(19) United States
(12) Patent Application Publication
(10) Pub. No.: US 2021/0204730 A1
(43) Pub. Date: Jul. 8, 2021

(54) GLASS TABLEWARE OR FURNITURE ITEM WITH LEG

(71) Applicant: ARC FRANCE, Arques (FR)

(72) Inventors: Jean-Luc HARION, Arques (FR); Philippe HARLAY, Arques (FR); Joël HENNEBIL, Arques (FR); Eric CARNEL, Arques (FR); Martial HAMEAU, Arques (FR); Sébastien DONZE, Arques (FR); José DUPLOUICH, Arques (FR)

(73) Assignee: ARC FRANCE, Arques (FR)

(21) Appl. No.: 16/954,821

(22) PCT Filed: Dec. 19, 2018
(86) PCT No.: PCT/FR2018/053410

§ 371 Date: Jun. 17, 2020

(30) Foreign Application Priority Data
Dec. 22, 2017 (FR) 1763076

(51) Int. Cl. A47G 19/22; B44C 5/04

(52) U.S. Cl. CPC A47G 19/2255; B44C 5/0407

(57) ABSTRACT

Tableware or furniture item (1) comprising a top part and a leg (4), produced in at least two parts:—the top part comprising a parison (2) or a support for another object and at least one annular stud (22) turned downwards, having at least one frustoconical outer surface (24) forming a buckling prevention member and provided with at least one lateral bulge (25) set apart from the base of the stud, and—the leg comprising an inner member (5) provided with a female link turned upwards to cooperate with the stud (22) of the top part, and comprising a plurality of concentric angular sectors (12) separated by slots (13), making said female link clamp the corresponding stud in the assembled position, and providing it with elasticity allowing it to pass over the lateral bulge during assembly, and an outer skirt (6).

### FIELD OF THE INVENTION

The present invention relates to the field of glass tableware, in particular of glassware, more specifically that of drinking glasses and the field of glass furniture objects.

### BACKGROUND

Glass furniture objects comprise: stem ashtrays, small tables, etc.

Conventional drinking glasses are often of variable stem, shaft and bowl or parison shapes according to the style, fashion, era, etc. Conventional drinking glasses are one-piece.

Various proposals of stemmed glasses produced in a plurality of portions have been made:

US 85 834 proposes a stemmed glass comprising a glass bowl connected to a metal standard by a screw-joint.

U.S. Pat. No. 5,014,865 describes a stemmed glass comprising a glass bowl, a cylindrical metal ferrule fastened to the glass bowl by a male-female connection bonded and provided with a female threading, a metal ring partially surrounding the ferrule and provided with a female threading, a shaft provided with a male threading turned upwards in connection with the female threading of the ring and with the female threading of the ferrule, and with a male threading turned downwards and a stem fastened to the male threading turned downwards.

U.S. Pat. No. 6,135,303 describes a stemmed glass comprising a bowl and a shaft fastened by locking on a spring, the shaft being surrounded by a ring, and a stem screwed at the bottom of the shaft.

FR 531 097 discloses a device for repairing a broken stemmed glass, whereof it remains a bowl provided with an bulged lower end. The device comprises a hollow metal socket-stem assembly. The socket accommodates a bolt, whereof the head is arranged on the underside of the stem. A conical split dice is forcibly clamped into the socket through the traction of the bolt, and is tightly connected on the bulge of the lower end of the bowl.

EP 1 314 383 relates to a modular glass with interchangeable portions, made of glass or crystal, comprising a base, a bowl and at least one stem, each able to be disconnected and freely associable with one another, the stem being of male-female type.

DD56453 proposes a stemmed flute made of flexible material provided with threaded female ends.

None of said solutions solves the problem of easy disassemblability whilst offering a high rigidity in the assembled state, and a freedom of design of the external appearance of the support.

The invention improves the situation.

### SUMMARY

According to one aspect of the invention, the glass tableware or furniture item comprises an upper portion and a leg, and is produced in at least two portions. The upper portion comprises a parison or a support for another object and at least one annular stud turned downwards. The stud has at least one frustoconical outer surface forming a buckling prevention member. The stud is provided with at least one lateral bulge set apart from the base of the stud. The leg comprises an inner member provided with a female link turned upwards to cooperate with the stud of the upper portion. The female link comprises a plurality of concentric angular sectors separated by slots, making said female link clamp the corresponding stud in the assembled position, and an elasticity enabling same to pass over the lateral bulge during assembly. The leg comprises an outer skirt.

The outer surface of the skirt is free of contact.

In one embodiment, the inner member and the outer skirt are coaxial.

The assembly is easy.

In one embodiment, the inner member is covered by the outer skirt.

The inner member is hidden by the skirt.

In one embodiment, the bulge is circular:

The rigidity is increased.

In one embodiment, the inner member is provided with a female link turned downwards to cooperate with a stud of a lower portion, the two female links being produced in a one-piece manner, said glass tableware or furniture item further comprising a lower portion comprising a stem and at least one annular stud turned upwards.

A good centering is obtained.

In one embodiment, the angular sectors have parallel edges in the assembled state.

A stable position may be obtained.

In one embodiment, each angular sector comprises a slot opened inwards.

An axial retention effect offers a good stability. The protrusion or lateral bulge has a slope allowing the disassembly.

In one embodiment, the outer skirt has protrusions projecting into said slots.

The skirt contributes to the stability of the angular sectors of the female link(s).

In one embodiment, the outer skirt is elastic.

In one embodiment, the outer skirt is over-injected on the inner member.

In one embodiment, the outer skirt is produced in elastomer.

The assembly is easy.

In one embodiment, the outer skirt has a bead projecting into an annular groove arranged on an outer surface of the inner member.

The outer skirt is axially stabilized.

In one embodiment, the outer skirt is set apart from the parison or from the support and from the stem.

In one embodiment, the outer skirt may have an outer surface of revolution.

The result thereof is a design independence.

In one embodiment, a glass item comprises a parison and a leg. The leg comprises an inner member provided with a female link turned upwards to cooperate with the stud integral with the parison. The stud has at least one frustoconical outer surface forming a buckling prevention member. The stud is provided with at least one lateral bulge set apart from the base of the stud. The female link comprises a plurality of concentric angular sectors separated by slots, making said female link clamp the corresponding stud in the assembled position, and an elasticity enabling same to pass over the lateral bulge during assembly.

In one embodiment, the inner member is provided with a female link turned downwards to cooperate with a stud integral with the stem, the two female links being produced in a one-piece manner, and an outer skirt.

The outer surface of the skirt may support furniture of aesthetic character.

In the assembled state, the stud of the lower portion and the stud of the upper portion are set apart.

The invention also proposes a method for manufacturing a glass tableware or furniture item, wherein:
a) a glass portion is manufactured by blow-pressing, centrifugation, blowing only, pressing only,
b) a glass stem comprising two studs joined by the ends thereof of small diameter is manufactured by pressing,
c) said glass portion and the stem are sealed by local melting at the base of the upper stud,
d) the two studs joined by the ends thereof are separated by hot-cutting between said ends to form said glass portion provided with a stud and the stem provided with a stud.

Alternatively, the blow-pressing is replaced by the blowing only or the centrifugation.

In other terms, the intermediate portion comprises two concentric members, an inner member configured to mechanically connect the lower portion and the upper portion by cooperating with the studs and a covering outer member. The intermediate portion is of female-female type.

The intermediate portion has an internal diameter of at least 5 mm, preferably 5.5 mm. The flow of water after washing is facilitated.

The intermediate portion is washable in a domestic or professional dishwasher.

Each angular sector, in the assembled state, exerts a clamping load on the corresponding stud.

The clipping obtained by the elastic sectors interacting with the bulge offers an axial retention in addition to the buckling stability and to the disassemblability.

The inner member comprises a rigid central portion provided with two opposite bores and with two end elastic portions, each located in the extension of one of said rigid bores. Each elastic portion is cut into at least three angular sectors. The inner member is devoid of threading.

Each stud has an outer surface of revolution. Each stud comprises a base portion and an end portion, the end portion being slightly frustoconical with a decreasing diameter by going opposite the base portion, the base portion also being frustoconical, substantially of same slope as the corresponding portion of the parison, with furthermore, a bulge or circular bead forming protrusion outwards. The bulge is located set apart from the end portion. In this way, the notches separating the angular sectors extend, in the assembled state, beyond the bulge. The bulge of the stud receives an axial force opposite to the axial force received by a shoulder at the base of the stud. The opposite axial forces may be of same value.

### BRIEF DESCRIPTION OF THE DRAWINGS

The present invention will be better understood upon studying the detailed description of one embodiment taken by way of non-limiting example and illustrated in the appended drawings:

FIG. 1 is an axial sectional view of an intermediate portion of stemmed glass according to one aspect of the invention;

FIG. 2 is an axial sectional view angularly offset in relation to FIG. 1;

FIG. 3 is an axial sectional view of a stemmed glass according to one aspect of the invention; and

FIG. 4 is a front view in elevation of a stemmed glass according to one aspect of the invention.

### DETAILED DESCRIPTION OF THE PREFERRED EMBODIMENTS

In the embodiment shown, the stemmed glass 1 consists of a one-piece parison 2, a one-piece stem 3 and a leg 4 produced in two parts. If applicable, the leg 4 produced in more than two parts with a rigid part extending between the stem 3 and the parison 2. Instead of the parison 2, a platform or a disc offering a flat surface, or a lighting globe for a lamp, or a water pipe with glass body, or a candleholder may be provided.

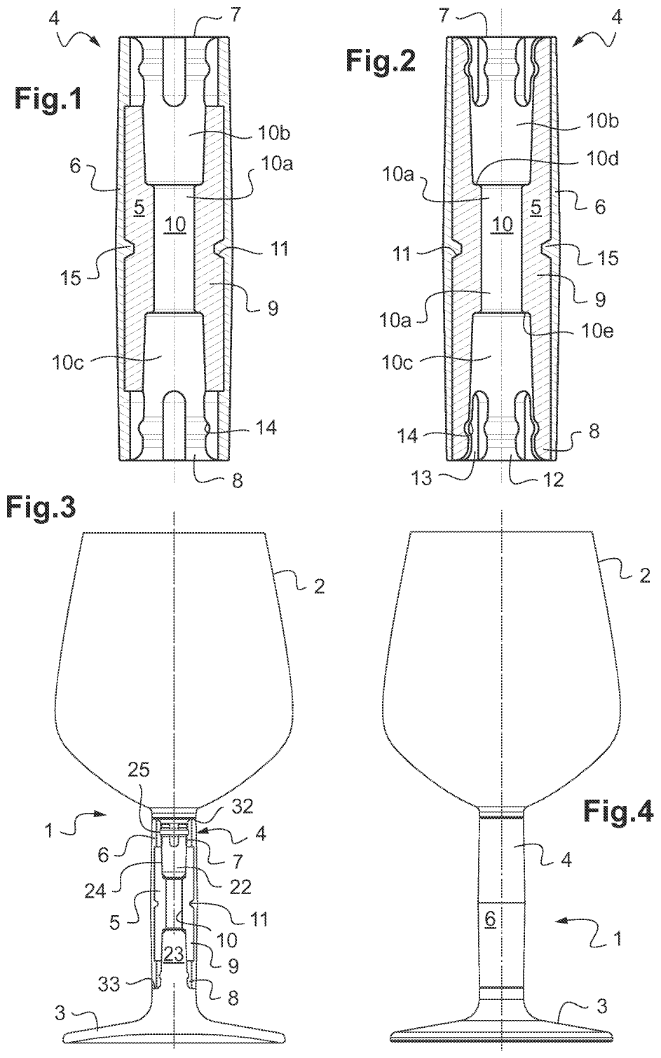

The leg 4 is illustrated in FIGS. 1 and 2. The leg 4 has an outer shape of revolution. The outer shape may be cylindrical. The leg 4 has a longitudinal axis, being located vertically during ordinary use of the glass 1 as a beverage container. The outer shape is thus free for arranging thereon drawings or aesthetically interesting three-dimensional shapes.

The leg 4 comprises an inner member 5 and an outer skirt 6. The inner member 5 and the outer skirt 6 are coaxial. The inner member 5 has a female link turned upwards and a female link turned downwards. The inner member 5 is one-piece. The inner member 5 is produced in synthetic material, for example in polypropylene.

The inner member 5 comprises a central portion 9 of shape of revolution and two opposite end portions 7 and 8. The central portion 9 is located in the extension of each of the end portions 7 and 8. The central portion 9 is hollow with a bore 10 oriented along the longitudinal axis. The bore 10 is through. The bore 10 has a cylindrical central portion 10a and two slightly frustoconical end portions 10b and 10c. The end portions 10b and 10c are flared opposite the central portion 10a. The end portions 10b and 10c are separated from the central portion 10a by respective shoulders 10d, 10e. Said shoulders 10d, 10e are set apart from a parison or stem stud. The length of each end portion 10b, 10c may be between 8 and 15 millimeters. The end portions 10b and 10c form female links suitable for cooperating with male links integral with the parison 2 and with the stem 3. The inner member 5 is reversible. The inner member 5 is devoid of locating hole.

The central portion 9 may have an outer surface of revolution, generally cylindrical with an annular slot 11 in central position. The slot 11 is at mid-distance between the end portions 7 and 8.

The end portions 7 and 8 have a plurality of lugs or angular sectors 12 separated by notches or cuttings 13. The angular sectors 12 have the same envelope as the outer surface of the central portion 9. The angular sectors 12 have an inner surface of annular envelope. Said inner surface is frustoconical. The angular sectors 12 are symmetrical in relation to the axis of the inner member 5.

The cuttings 13 are generally U-shaped. The cuttings 13 have edges parallel to the axis of the inner member 5, in the assembled state of the glass. The cuttings 13 have a length less than the length of an end portion 10b, 10c of the bore 10. The length of the angular sectors 12 may be between 6 and 15 millimeters.

In the embodiment shown, the angular sectors 12 are four in number. Alternatively, a number of angular sectors 12 between three and ten is possible depending, in particular, on the diameter of the inner member 5. The angular sectors 12 form jaw pliers. An even number of jaws, for example four, make it possible to arrange a possible pair of irregularities of the glass diametrically opposite after molding, in the notches or cuttings 13.

The inner member 5 is symmetrical in relation to the longitudinal axis thereof. The inner member 5 has a symmetry in relation to a normal central plane with said longitudinal axis.

A groove 14 is arranged in each end portion 10b, 10c of the bore 10. The groove 14 is of annular envelope. The groove 14 is located in the region of the angular sectors 12. The groove 14 is arranged in each angular sector 12. The groove 14 is located closer to the free end of the inner member 4 than to the bottom of the notches 13. The groove 14 has a rounded cross-sectional profile. The groove 14 has a bottom radius between 1 and 2 millimeters. Beyond the groove 14 in direction of the free end of the inner member 5, the inner surface of the angular sectors 12 finds the frustoconical inner envelope.

Alternatively, each angular sector has a lateral protrusion forming a releasable hook turned inwards.

The free end of the inner member 5 has a radial frontal surface. Between the radial frontal surface and the frustoconical envelope of the end portion 10b, 10c, is provided a fillet of radius greater than the bottom radius of the groove 14. Thus, the angular sectors 12 are guided for coming into contact with the stud 22, 23. The connection between the radial frontal surface and the outer surface of the inner member 5 is sharp, in particular with a connection radius as reduced as possible.

The outer skirt 6 has a thickness less than 2 mm, preferably less than 1.5 mm. The outer skirt 6 may be overmolded on the inner member 5. The outer skirt 6 has an outer surface of revolution. Said outer surface may be slightly frustoconical, for example with an angle between 0.5 and 2°. The outer skirt 6 has two opposite radial surfaces coplanar with the end radial frontal surfaces of the inner member 5.

Alternatively, the skirt 6 and the inner member 5 are produced in the same material. The skirt 6 and the inner member 5 are therefore one-piece.

Optionally, the outer skirt 6 has a radial bead 15 projecting into the slot 11 of the inner member 5. The bead 15 is annular. The bead 15 and the slot 11 provide a holding of the relative position of the outer skirt 6 and of the inner member 5 during the manufacturing and over time.

The outer skirt 6 is angularly continuous. Between two angular sectors 12, the outer skirt 6 slightly protrudes in the notch 13. The radial dimension of the projection is less than the radial dimension—the thickness—of the angular sectors 12.

The outer skirt 6 is produced in flexible material, for example in elastomer, more specifically in thermoplastic elastomer TPE, for example of Shore hardness 40±20%. The outer skirt 6 mainly essentially consists of an elastic tube. The wall of the outer skirt 6 is watertight. The material of the outer skirt 6 is watertight. The structure of the outer skirt 6 is watertight. The outer skirt 6 reinforces the holding of the leg 4 on the studs 22 and 23 by clamping of the angular sectors 12.

In other terms, the glass leg comprises an inner member provided with a female link turned upwards to cooperate with a stud of the parison, and with a female link turned downwards to cooperate with a stud of the stem, the two female links being produced in a one-piece manner, and an outer skirt. Each female link is formed by a frustoconical surface providing a wedging for maintaining the coaxiality, and an elastic axial locking slot.

The parison 2 is associated with an upper stud 22 to form the upper portion of the stemmed glass 1.

The stem 3 is associated with a lower stud 23 to form the lower portion of the stemmed glass 1.

The upper stud 22 and the lower stud 23 are identical and oriented towards one another. Each stud 22, 23 has an essentially frustoconical outer surface 24 provided with an annular bulge 25. The outer surface 24 has a small slope between 1 and 5°. Each stud 22, 23 is terminated by a radial free end connected to the outer surface 24 by a connection radius. Each stud 22, 23 is connected to the parison 2, respectively to the stem 3, by a substantially radial shoulder 32, 33. The length of the stud 22, 23 is greater than double the diameter of said stud 22, 23. More specifically, the length of the outer surface 24 is greater than double the diameter of said outer surface 24.

The annular bulge 25 is arranged at a height of the stud 22, 23 between 10 and 25% of the total height taken between the shoulder and the radial free end. The annular bulge 25 has a radial dimension between 0.2 and 0.5 mm.

In other terms, each stud 22, 23 has a head portion corresponding to the circular portion of the inner member 5 and a base portion corresponding to the angular sectors 13. The concordance of shapes between each stud 22, 23 and the inner member 5 provide a stable resistance. The tightened interlocking of the head portion of each stud 22, 23 in the circular portion of the inner member 5 offers good resistance of the assembly to buckling. The elastic clamping provided by the angular sectors 12 around the base portion of each stud 22, 23 makes possible an axial retention between the leg 4 and the stud 22, 23.

Upon assembly, the head portion of each stud 22, 23 passes between the angular sectors 12 that may provide a guide if necessary, then engages in the end portion 10a, 10b of the bore 10, in other terms in the hollow circular portion of the inner member 5. The bulge 25 comes into contact with the rounded inlet of the angular sectors 12. The continuation of the axial movement of assembly, results in the radial spacing of the ends of the angular sectors 12 with deflection of the angular sectors 12 in arc of circle towards the outside.

At the end of movement, the bulge 25 is lodged into the annular slot or groove 14 enabling thus the elastic return of the angular sectors 12 into the substantially original position thereof. The free end of the stud 22, 23 is then arranged in the immediate vicinity of the shoulder delimiting the central portion 10a of the bore 10 of the inner member 5. The elastic return of the angular sectors 12 into the original position thereof may result in a slight noise generator clicking reassuring the user on the reality and the holding of the assembly between the leg 4 and the parison 2 or the stem 3.

The stem 3 has a shape providing the stability of the glass. In the embodiment shown, the stem 3 has a flared circular shape with an annular lower contact surface and a hollow in the underside.

The parison 2 has a shape compatible with the stud 22. In the embodiment shown, the parison 2 has a circular shape with maximum diameter located in the lower half of the parison 2.

Thus, each female link comprises a plurality of concentric angular sectors separated by slots, making said female link clamp the corresponding stud in the assembled position, and an elasticity enabling same to pass over the lateral bulge during assembly.

In the assembled state, the shoulder 32 between the stud 22 and the parison 2 is in contact with the upper end of the leg 4. In the embodiment shown, the upper end of the leg 4 consists of the end of the outer skirt 6 and the end of the inner member 5 in the form of free ends of the angular sectors 12. Similarly, the shoulder 33 between the stud 23 and the stem 3 is in contact with the lower end of the leg 4. In the embodiment shown, the lower end of the leg 4 consists of the end of the outer skirt 6 and the end of the inner member 5 in the form of free ends of the angular sectors 12. A compressive force is transmitted by the interface cone between the stud 22, 23 and the end portion of the bore 10b, 10c. The free end of the studs 22 and 23 may be a short distance from said shoulders.

A buckling force, corresponding to a twisting in a plane passing through the axis of the stemmed glass, is taken up by the cone/cone link between the end portions 10b and 10c, in particular the circularly continuous region, and the outer surfaces of the studs 22 and 23.

Alternatively, the angular sectors 12 are set apart from the parison and from the stem. The skirt 6 may be in contact with the parison and the stem.

During assembly, each female link is brought opposite the corresponding stud. A relative axial movement between the leg and the stem, between the leg and the parison is performed. The stud passes between the angular sectors or lugs and progressively moves apart same. The stud engages in the circular bottom of the female link whereas the bulge close to the base of the stud more significantly moves apart the angular sectors. The stud comes into contact with the frustoconical portion of the female link whereas the bulge close to the base of the stud reaches the slot of the angular sectors and the angular sectors tighten. A possible clicking indicates that the clipping has indeed taken place.

The disassembly may be performed by axial traction of the leg and of the stem, respectively of the leg and of the parison.

The upper portion—parison and stud—may be clipped on a leg same clipped on a stem to form a stemmed glass as well as on a support comprising a female link cooperating with the stud of the upper portion. The support may comprise a handle and a stem to form a cup. The support may consist of a stem to form a glass without leg, of beaker type.

In one embodiment, a tableware item, for example a drinking glass, comprises a parison, a leg and a stem. The stemmed glass is produced in at least three portions:
an upper portion comprising the parison and at least one annular stud turned downwards,
a lower portion comprising the stem and at least one annular stud turned upwards, and
an intermediate portion comprising an inner member provided with a female link turned upwards to cooperate with the stud of the upper portion, and with a female link turned downwards to cooperate with the stud of the lower portion, the two female links being produced in a one-piece manner, and an outer skirt.

In one embodiment, a furniture item comprises a support portion for third-party objects, and a leg. The item is produced in at least two portions:
an upper portion comprising the support portion and at least one annular stud turned downwards,
the leg comprising an inner member provided with a female link turned upwards to cooperate with the stud of the upper portion, and an outer skirt.

A stem may be provided one-piece with the leg or provided with a fastening with the leg.

In one embodiment, the inner member is configured to mechanically connect the lower portion and the upper portion and is covered by the outer skirt.

In one embodiment, each stud comprises at least one lateral bulge set apart from the base of the stud, preferably circular.

In one embodiment, each stud comprises at least one frustoconical outer surface forming a buckling prevention member.

In one embodiment, each female link comprises a plurality of concentric angular sectors separated by slots, making said female link clamp the corresponding stud in the assembled position, and an elasticity enabling same to pass over the lateral bulge during assembly.

In one embodiment, the angular sectors have parallel edges in the assembled state.

In one embodiment, each angular sector comprises a slot opened inwards.

In one embodiment, the outer skirt has protrusions projecting into said slots.

In one embodiment, the outer skirt has an outer surface of revolution.

In one embodiment, a stemmed glass leg comprising a parison, a leg and a stem, comprises an inner member provided with a female link turned upwards to cooperate with a stud integral with the parison, and with a female link turned downwards to cooperate with a stud integral with the stem, the two female links being produced in a one-piece manner, and an outer skirt.

The manufacturing may take place by producing on one hand a glass portion, in particular a parison, by blow-pressing, centrifugation, blowing only or pressing only. The blow-pressing implements a blank mold wherein a drop of glass is poured and a blow mold receiving a blank coming from the blank mold and dilating same by air overpressure. On the other hand, a glass stem is produced by pressing in a single mold. The stem has two studs joined by the ends thereof of small diameter. The join may be of annular groove form, hence a reduced material diameter, or of flush form. Said glass portion and the stem are sealed by local melting of the glass. The seal is located at the base of the stud. Then, the two studs joined by the ends thereof are separated, in particular, by hot cutting between said ends. Thus, said glass portion is formed provided with a stud and the stem provided with a stud. Thus, each of the two portions may be provided with a stud.

1. Glass tableware or furniture item (1) comprising an upper portion and a leg (4), produced in at least two portions:
the upper portion comprising a parison (2) or a support for another object and at least one annular stud (22) turned downwards, having at least one frustoconical outer surface (24) forming a buckling prevention member and provided with at least one lateral bulge (25) set apart from the base of the stud, and
the leg comprising: an inner member (5) provided with a female link turned upwards to cooperate with the stud (22) of the upper portion, and comprising a plurality of concentric angular sectors (12) separated by slots (13), making said female link clamp the corresponding stud in the assembled position, and elasticity enabling the female link to pass over the at least one lateral bulge during assembly, and an outer skirt (6).

2. The glass tableware or furniture item according to claim 1, wherein the inner member (5) and the outer skirt (6) are coaxial.

3. The glass tableware or furniture item according to claim 1, wherein the inner member (5) is covered by the outer skirt (6).

4. The glass tableware or furniture item according to claim 1, wherein the bulge (25) is circular.

5. The glass tableware or furniture item according to claim 1, wherein the inner member (5) is provided with a female link turned downwards to cooperate with a stud (23) of a lower portion, the two female links being produced in a one-piece manner, said glass tableware or furniture item further comprising a lower portion comprising a stem (3) and at least one annular stud (23) turned upwards.

6. The glass tableware or furniture item according to claim 1, wherein the angular sectors (12) having parallel edges in the assembled state.

7. The glass tableware or furniture item according to claim 6, wherein each angular sector (12) comprises a slot (14) opened inwards.

8. The glass tableware or furniture item according to claim 7, wherein the outer skirt (6) has protrusions projected into said slots.

9. The glass tableware or furniture item according to claim 1, wherein the outer skirt (6) is elastic, over-injected on the inner member and/or produced in elastomer.

10. The glass tableware or furniture item according to claim 1, wherein the outer skirt (6) has a bead (15) projecting into an annular groove (11) arranged on an outer surface of the inner member.

11. The glass tableware or furniture item according to claim 1, wherein the outer skirt (6) is set apart from the parison (2) and from the stem (3).

12. Glassware item comprising a parison (2), and a leg, said leg comprising an inner member (5) provided with a female link turned upwards to cooperate with a stud (23) integral with the parison (2), the stud having at least one frustoconical outer surface (24) forming a buckling prevention member and provided with at least one lateral bulge (25) set apart from the base of the stud, the female link comprising a plurality of concentric angular sectors (12) separated by slots (13), which cause said female link to clamp the corresponding stud in the assembled position, and elasticity enabling said female link to pass over the lateral bulge during assembly.

13. The glassware item according to claim 12, wherein the inner member (5) is provided with a female link turned downwards to cooperate with a stud (23) integral with the stem, the two female links being produced in a one-piece manner, and an outer skirt (6).

14. A method for manufacturing an item according to claim 5, wherein:
a) a glass portion is manufactured by blow-pressing,
b) a glass stem comprising two studs joined by the ends thereof of small diameter is manufactured by pressing,
c) said glass portion and the stem are sealed by local melting at the base of the upper stud, and
d) the two studs joined by the ends thereof are separated by hot-cutting between said ends to form said glass portion provided with a stud and the stem provided with a stud.
